(19) United States
(12) Patent Application Publication
(10) Pub. No.: US 2016/0053952 A1
(43) Pub. Date: Feb. 25, 2016

(54) SMART LUMINAIRE

(71) Applicant: GE LIGHTING SOLUTIONS, LLC, East Cleveland, OH (US)

(72) Inventors: Andras KUTI, Budapest (HU); Daniel LORINCZ, Budapest (HU); Roland BATAI, Budapest (HU); Norbert KOVACS, Budapest (HU); Laszlo BALAZS, Godollo (HU); Andras SINKA, Budapest (HU); Monika JEHN, Budapest (HU); Istvan MAROS, Budapest (HU); Peter SCHWARCZ, Budapest (HU); Tamas PANYIK, Budapest (HU)

(21) Appl. No.: 14/833,802

(22) Filed: Aug. 24, 2015

Related U.S. Application Data
(60) Provisional application No. 62/041,638, filed on Aug. 25, 2014.

(51) Int. Cl. F21S 8/08; F21V 3/02; F21V 5/00; F21V 17/06; F21V 17/10; F21V 31/00; F21V 21/116; F21V 23/00; F21V 23/06; F21V 27/02; F21V 29/70; F21S 6/00; F21V 19/00

(52) U.S. Cl. CPC F21S 8/086; F21S 6/006; F21V 3/02; F21V 5/007; F21V 17/06; F21V 17/101; F21V 19/003; F21V 21/116; F21V 23/005; F21V 23/06; F21V 27/02; F21V 29/70; F21V 31/005; F21W 2131/103

(57) ABSTRACT

A street lighting assembly includes an LED lighting device and a printed circuit board disposed within the LED lighting device. The printed circuit board includes an LED light module and an LED driver, the LED driver being electrically coupled to the LED light module. An optical cover is disposed over the LED light module.

### FIELD

The aspects of the present disclosure relate generally to street lighting fixtures. In particular, the aspects of the disclosed embodiments are directed to an LED street lighting fixture.

### BACKGROUND

Street lighting lamps or luminaires are generally designed for long life operation. The typical street lamp will generally include a weather proof, robust, cast aluminium housing that is mounted on a pole. The lighting components, such as a light source and electrical driver, are incorporated into the aluminium housing. The different components and functionalities of this type of street lamp including the housing, optics and electrical gear, are separated and designed to be serviced on the pole. The components can have removable mechanical and electrical connections that allow for servicing and quick replacement of components. Due to the short life span of components such as the discharge lamps, the lamps and electrical components might be replaced several times during the life span of such a street light luminaire.

Light emitting diode (LED) devices provide increased lifetime and reliability of the LED lighting components. In some cases, the lifetime and reliability of the LED lighting components can approach the expected lifetime of the entire luminaire. It would be advantageous to simplify the luminaire design by eliminating features that are designed for recurring service of the luminaire.

A typical street light assembly will include a number of different parts that are coupled together. It would be advantageous to reduce or eliminate the number of parts, including bolts and fasteners used in the street lighting fixture. Reducing the number of parts in a street lighting fixture will also advantageously simply the manufacturing of street lighting luminaires.

Conventional LED fixtures include two main types, reflector based fixtures and lens based fixtures. In some cases the reflector based fixtures and lens based fixtures can be covered by a cover glass. The hardness and resistance of the glass protects the reflector/lens against dust, water, impact and vandalism. With certain type of cover glass there can be significant light reflection upwards. It would be advantageous to minimize the amount of upward light reflection.

The electrical components on an LED luminaire will include an LED module or chip and an LED driver or power supply. In a street lighting assembly, the LED modules and LED drivers are separate, individual components with their own housings, connectors and cables. It would be advantageous to minimize the number of individual housings, connectors and cables needed in an LED street lamp assembly to reduce the number of parts and the associated costs.

The LED module and LED driver generate heat. The heat generated by the LED driver and LED module can result in overheating, which causes failure. It would be advantageous to package the LED driver and LED module in a manner that minimizes the effects of generated heat.

The coupling between the lamp and the lamp pole is typically made inside the lamp housing with metal straps or bolts. These coupling devices can only be loosened up from inside of the lamp housing. This can make lamp settlement or repair difficult. It would be advantageous to provide a street lamp coupling assembly that allows for easy attachment of a lamp to a lamp pole.

In lamps with different optical parts, different tools can be required during manufacturing. The need for different tools increases the cost and complexity of the manufacturing process. It would be advantageous to be able to reduce the number of injection moulding tools needed during the manufacturing of a street lighting assembly.

Accordingly, it would be desirable to provide an LED street lighting assembly that addresses at least some of the problems identified above.

### BRIEF DESCRIPTION OF THE DISCLOSED EMBODIMENTS

As described herein, the exemplary embodiments overcome one or more of the above or other disadvantages known in the art. One aspect of the exemplary embodiments relates to a street lighting assembly. In one embodiment, the street lighting assembly includes an A street lighting assembly includes an LED lighting device and a printed circuit board disposed within the LED lighting device. The printed circuit board includes an LED light module and an LED driver, the LED driver being electrically coupled to the LED light module. An optical cover is disposed over the LED light module.

In other aspect, the aspects of the disclosed embodiments are directed to a street lighting assembly. In one embodiment, the street lighting assembly includes an LED lighting device and a pole member. A modular connector unit couples the LED lighting device to the pole member. An optical cover is disposed over a lighting portion of the LED lighting device. The LED lighting device includes a printed circuit board, an LED light module disposed on the printed circuit board and an LED driver disposed on the printed circuit board.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIGS. 1A-1D are side views of exemplary street light assemblies incorporating aspects of the disclosed embodiments;

FIGS. 2A-2H illustrate an exemplary street light assembly incorporating aspects of the disclosed embodiments;

FIGS. 3A-3E and 4 are side views of exemplary street lighting fixture assemblies incorporating aspect of the disclosed embodiments;

FIGS. 5 and 6 illustrate an exemplary plug assembly for a street lighting fixture assembly incorporating aspects of the disclosed embodiments;

FIG. 7 illustrates an exemplary bumper member for a street lighting fixture assembly incorporating aspects of the disclosed embodiments;

FIG. 8 illustrates a cross-section of an injection moulded housing showing the printed circuit board and lens assembly for a street lighting fixture assembly incorporating aspects of the disclosed embodiments;

FIG. 9 is a front plan view of an optical lens part for a street lighting fixture assembly incorporating aspects of the disclosed embodiments;

FIG. 10 is a front perspective view of a manufacturing tool incorporating aspects of the disclosed embodiments;

FIG. 11 is a side view of an exemplary street lighting assembly incorporating aspects of the disclosed embodiments.

FIGS. 12-13 illustrates an exemplary dowel connection member for a street lighting assembly incorporating aspects of the disclosed embodiments;

FIGS. 14-16 illustrates an exemplary stretcher member for a street lighting fixture assembly incorporating aspects of the disclosed embodiments;

FIG. 17 illustrates an exemplary dowel connection member in an uncompressed or not tightened state for a street lighting assembly incorporating aspects of the disclosed embodiments;

FIG. 18 illustrates an exemplary dowel connection member in a compressed or tightened state for a street lighting assembly incorporating aspects of the disclosed embodiments;

FIG. 19 illustrates the blind plug access opening for a street lighting assembly incorporating aspects of the disclosed embodiments;

FIG. 20 illustrates a cap member for the blind plug access opening shown in FIG. 19;

FIG. 21 illustrates an alternative embodiment of a connection assembly for a street lighting assembly incorporating aspects of the disclosed embodiments;

FIGS. 22 and 23 illustrate an exemplary coupler device for a street lighting assembly incorporating aspects of the disclosed embodiments; and

FIGS. 24 and 25 illustrate the angled configuration of a lamp assembly for a street lighting assembly incorporating aspects of the disclosed embodiments.

### DETAILED DESCRIPTION OF THE EXEMPLARY EMBODIMENTS OF THE DISCLOSURE

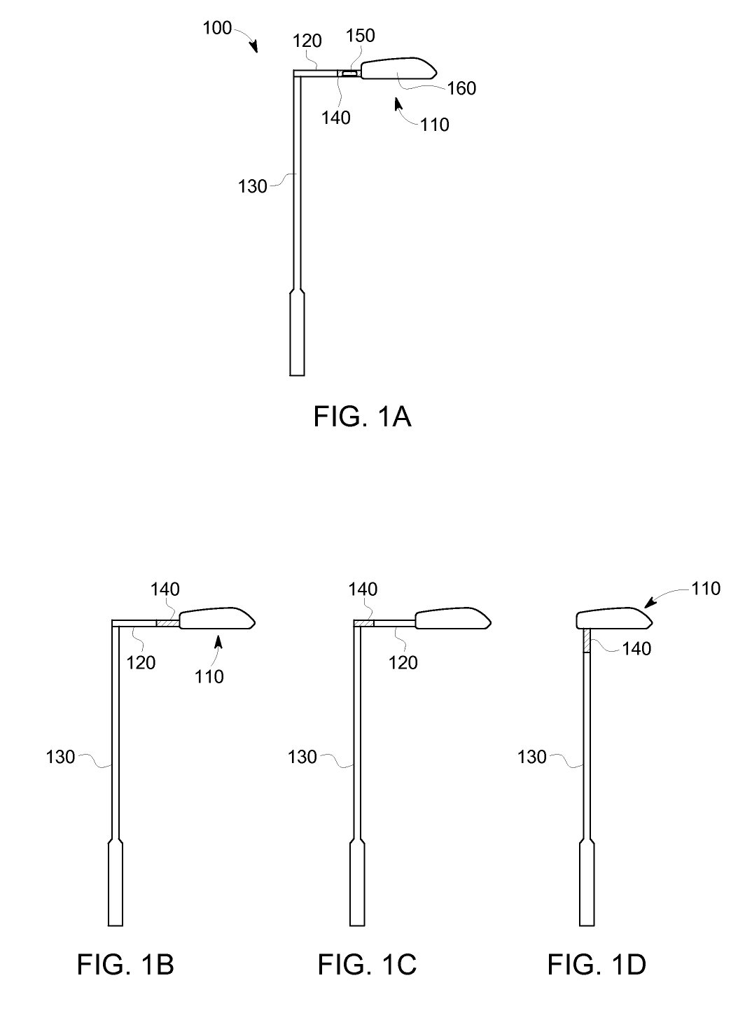

FIG. 1A illustrates a side view of one embodiment of a street light assembly 100 incorporating aspects of the present disclosure. In the example of FIG. 1A, the street light assembly 100 includes a lighting assembly 110, a pole arm 120 and a pole 130, the pole arm 120 and pole 130 also being referred to collectively as a “pole member.” In one embodiment, the lighting fixture assembly or luminaire 110 is coupled to one or more of the pole arm 120 or pole 130. In one embodiment, the lighting assembly 110 can be coupled directly to the pole 130, without a pole arm 120. Alternatively, the aspects of the disclosed embodiments provide for use of the lighting assembly 110 without a pole member.

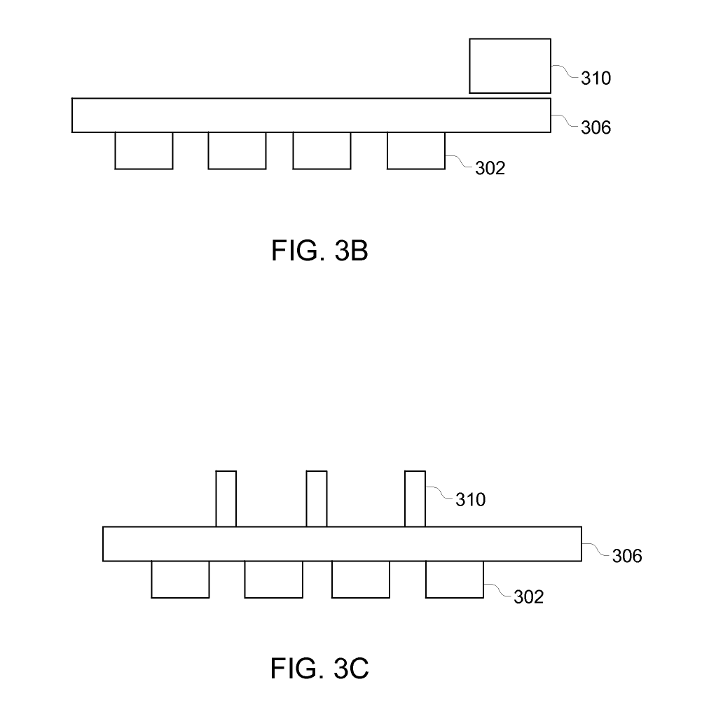

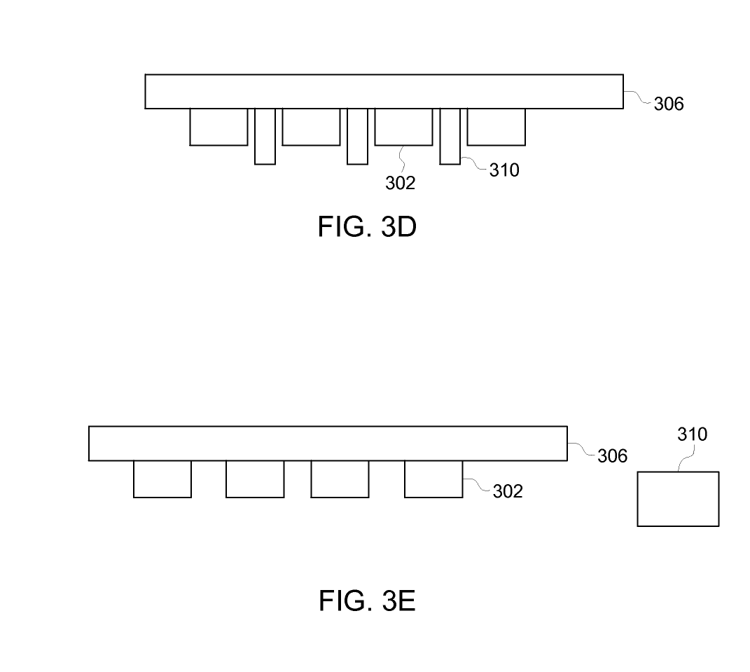

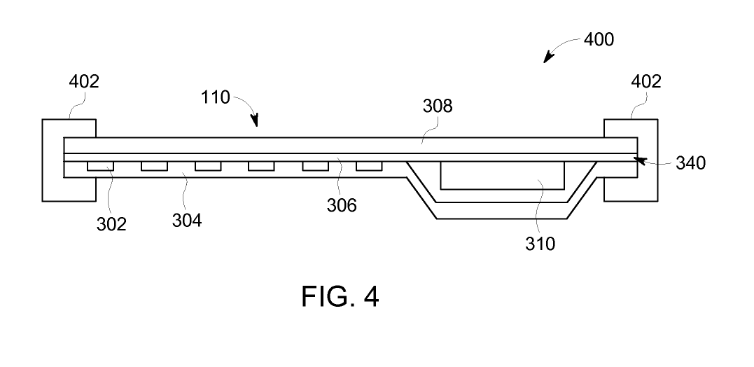

In the example shown in FIG. 1A, the pole arm 120 is connected to the pole 130. The pole 130 is configured to secure the street light assembly 100 in place, such as in the ground or a stationary structure such as a wall or post member. The aspects of the disclosed embodiments are not limited as to how the pole 130 secures the street light assembly 100 in place. In alternate embodiments, the street light assembly 100 can include any other suitable components for providing lighting as is generally disclosed herein. As is illustrated in FIG. 1A, in one embodiment, the lighting assembly 110 includes or is coupled to a modular connector unit 140. The modular connector unit 140 is used to couple or connect a light portion 160 of the lighting assembly 110 to the pole 120 or pole arm 130, depending on the particular configuration. The light portion 160 generally comprises or includes an LED light or LED lighting assembly, also referred to as an LED module. As will be described further herein, the light portion 160 will also include or be electrically coupled to a driver or power supply for the LED module. The driver or power supply, also referred to as the LED driver, will be disposed on a printed circuit board of the light portion 160. In one embodiment, as is described further herein and shown in FIGS. 3 and 4, both the LED module and the LED driver will be disposed on the printed circuit board.

While the aspects of the disclosed embodiments will generally be described herein with respect to the LED driver and LED module being disposed on the same circuit board, in one embodiment, the modular connector unit 140 can be used to house or include the LED driver for the lighting assembly 110. The aspects of the disclosed embodiments also allow for the LED driver to be placed in part or in whole in the modular connector unit 140, outside of the light portion 160.

In one embodiment, referring to FIG. 1A, an LED driver module 150 can be included or coupled to the modular connector unit 140. In this example, the LED driver module 150 can include the LED driver referred to above. The LED driver module 150 is used to provide the electrical power and signalling to activate the light portion 160. The aspects of the disclosed embodiments also provide for the LED driver module 150 to be disposed away from the light module 160. As is shown in the example of FIG. 1A, the LED driver module 150 is disposed within the modular connector unit 140. In alternate embodiments the LED driver module 150 can be disposed in any suitable location, such as within the pole 130 or the pole arm 120 or on the printed circuit board with the LED module within the light portion 160.

Although the modular connector unit 140 is shown in the embodiment of FIG. 1A as being coupled between, and connecting the pole arm 120 and the lighting assembly 110, in alternate embodiments, the modular connector unit 140 can be disposed in an suitable location. For example, in FIG. 1B, the modular connector unit 140 is disposed between the lighting assembly 110 and the pole arm 120. In FIG. 1C, the modular connector unit 140 is disposed between, and connects, the pole arm 120 and the pole 130. In the example of FIG. 1D, the modular connector unit 140 couples the lighting assembly 110 to the pole 130, without an intervening pole arm. In an alternate embodiment, a conduit box (not shown) can be provided in a lower part of the pole 130. The modular connector unit 140 could be included within the conduit box.

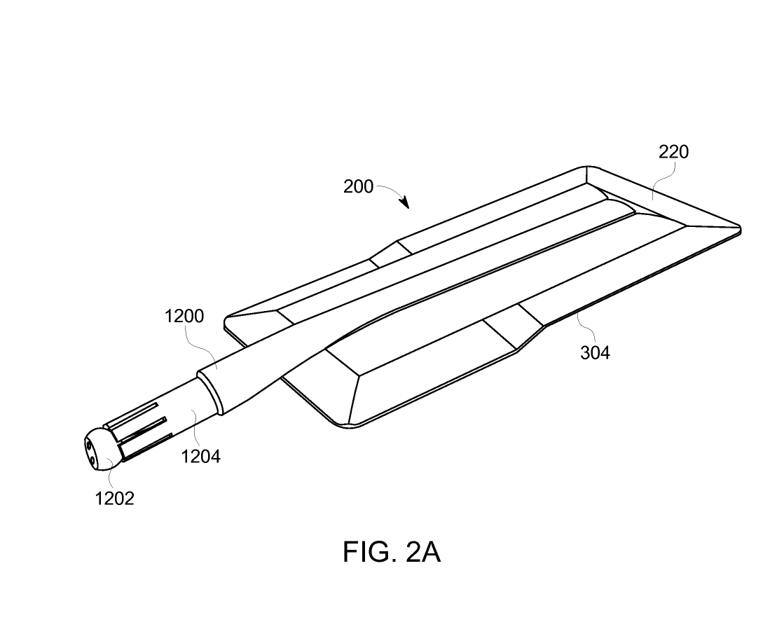

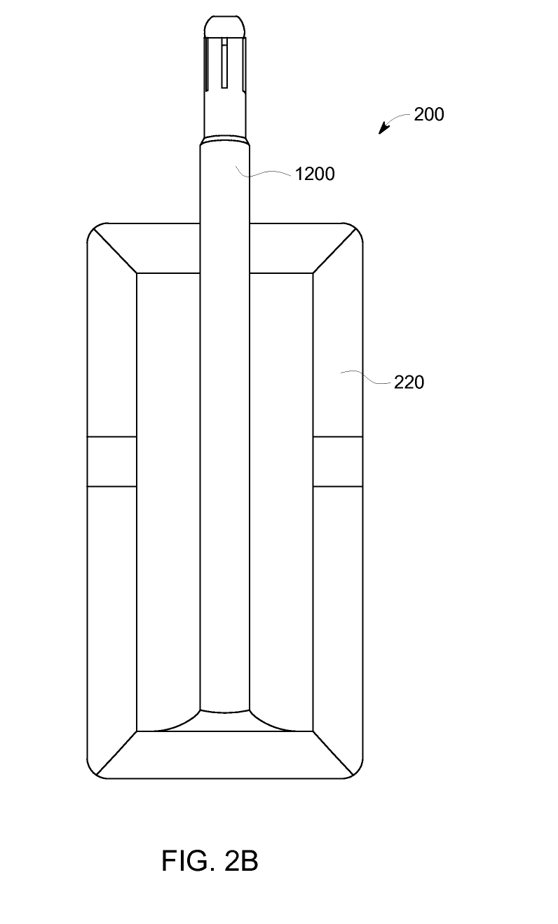

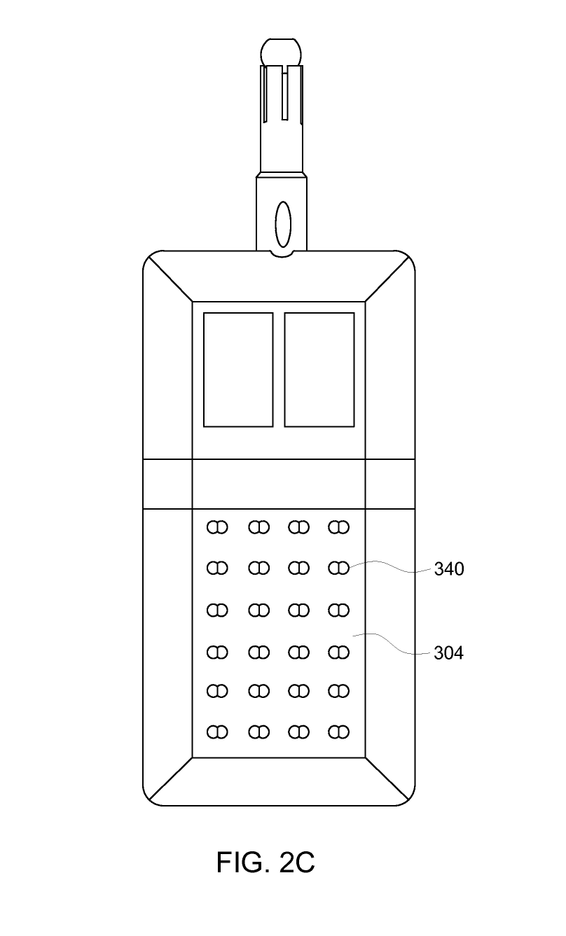

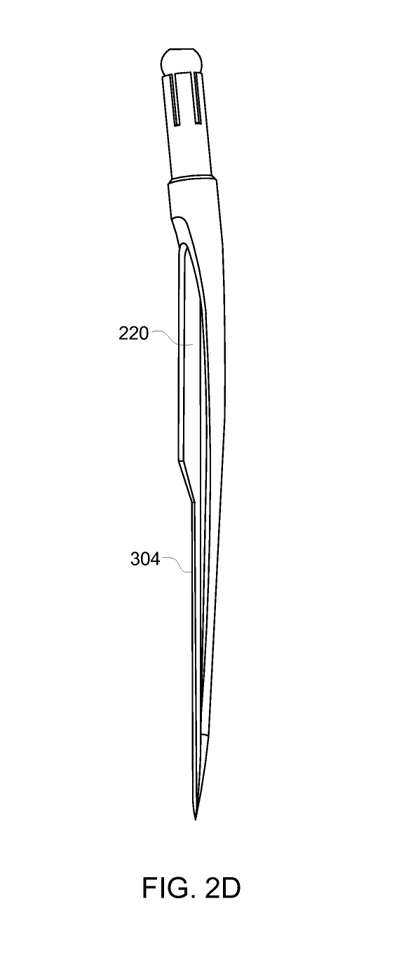

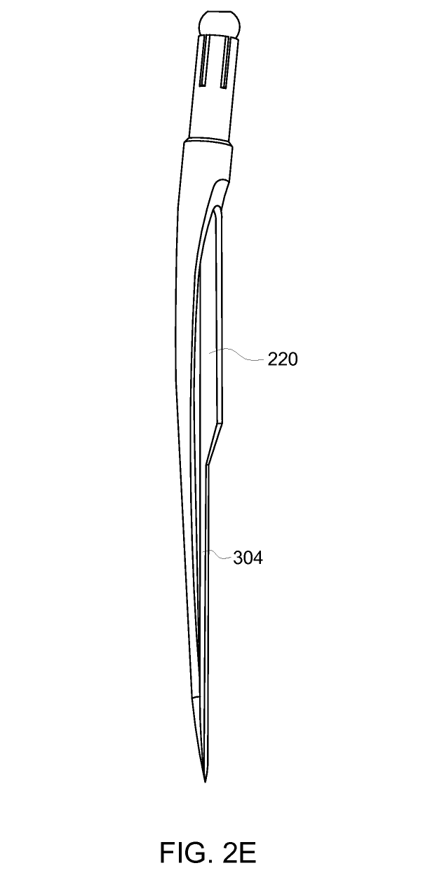

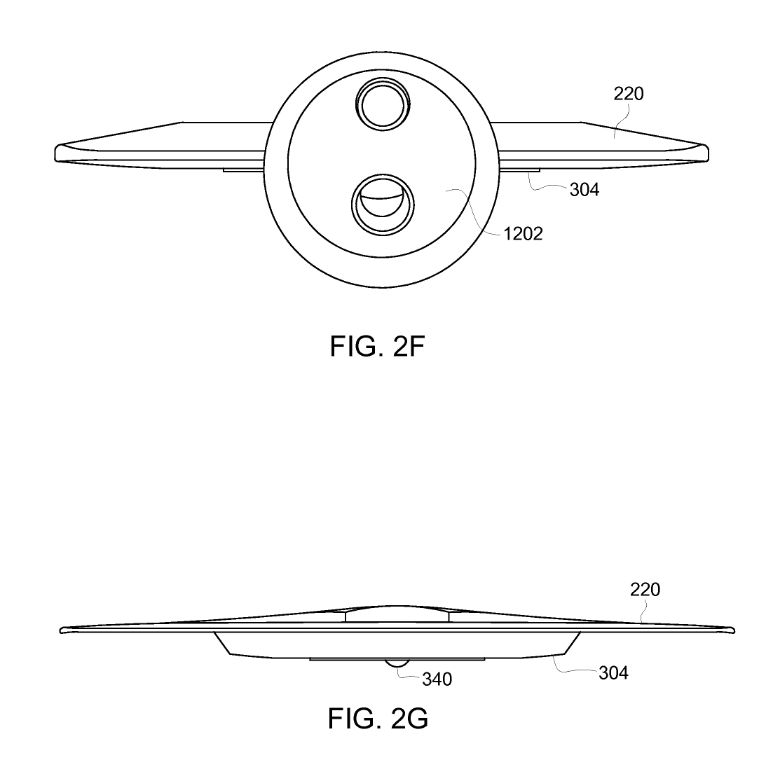

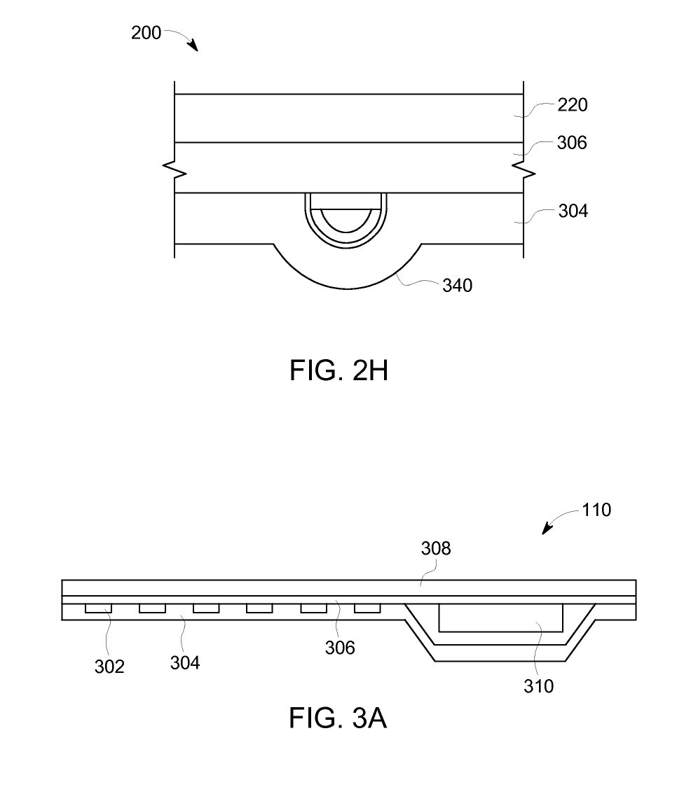

FIGS. 2A-2H illustrate an exemplary LED luminaire assembly 200 incorporating aspects of the disclosed embodiments. The LED luminaire assembly 200 generally includes the lighting assembly 110 shown in FIGS. 1A-1D. In this example, the luminaire assembly 200 is substantially flat in shape and form. The LED luminaire assembly 200 includes an upper housing 220 and a front lens portion or cover 304. In one embodiment, the upper housing 220 comprises a plastic material and is welded to the front lens portion 240. The front lens portion 240 comprises a transparent cover with LED lenses 304 disposed therein, as is shown in the example of FIG. 2H.

Referring to FIG. 2H, in one embodiment, the printed circuit board 206 for the electrical components of the LED luminaire assembly 200 is disposed within the housing 220. The printed circuit board 206 can be overmolded with the material of the plastic upper housing 220. In this example, the front lens portion 304 and the upper housing 220 are welded together. This provides a rugged and weather resistant luminaire assembly 200.

FIG. 3A illustrates one embodiment of an LED luminaire or lighting assembly 110 incorporating aspects of the present disclosure. The LED lighting assembly 110 can comprise the light portion 160 of FIG. 1A or the LED luminaire assembly 200 of FIG. 2A. The aspects of the disclosed embodiments provide an outdoor, street lighting fixture, in which all of the electrical components, such as the LED light sources or modules, LED driver, housing, mechanical connections and plugs can be integrated together. The parts with different functions, such as the light sources, light distributor and heat sink, can be integrated into a moulded polymer part, or housing. The use of bolts and fasteners to secure the different components to a base or together can be avoided.

In the example of FIG. 3A, the LED lighting assembly 110 includes an LED module 302, a front lens portion 304, also referred to as an optical cover part 304, a printed circuit board 306 and an LED driver module 310. In one embodiment, the LED assembly 110 can include a heat sink 308 that is coupled to or part of the printed circuit board 306. Although the heat sink 308 is shown as a separate component in the example of FIG. 3A, in alternate embodiments, the heat sink 308 is part of, or embodied in, the printed circuit board 306.

In one embodiment, the LED module 302 can comprise one or more LED chips or an array of LED chips. In the example of FIG. 3A, there are six LED modules 302, which may be referred to as an LED array. In alternate embodiments, any suitable number of LED modules 302 can be included, other than including six. For example, only one LED module 302 may be provided, the LED module 302 including one or more LED chips. The aspects of the disclosed embodiments are not limited by the number of LED modules 302 or chips that are incorporated in the LED assembly 300.

The LED driver 310, also referred to as a power supply, is generally configured to provide the electrical power and signals needed to operate the LED module(s) 302, as was generally described with respect to FIGS. 1A-1D. The aspects of the disclosed embodiments allow the LED driver 310 to be suitably positioned with the LED module(s) 302 on the printed circuit board 306. Alternatively, as was described with respect to the example of FIG. 1A, the LED driver 310 can be separate from the LED module(s) 302 and printed circuit board 306.

In the example of FIG. 3A, the LED driver 310 is positioned on the same side of the printed circuit board 306 as the LED module(s) 302. In the example of FIG. 3B, the LED driver 310 is shown positioned on the back side of the printed circuit board 306, opposite the side of the printed circuit board 306 on which the LED module(s) 302 are disposed.

In one embodiment, the LED driver 310 comprises a distributed power supply. In the example of FIG. 3C, the distributed power supply is disposed on the back side of the printed circuit board 306, opposite the side on which the LED module(s) 302 are disposed. In the example of FIG. 3D, the distributed power supply is disposed on the same side of the printed circuit board 306, with the distributed portions of the LED driver 310 being interspersed between the LED modules 302.

Although the aspects of the disclosed embodiments are generally described herein with the LED driver 310 being disposed on the printed circuit board 306, the aspects of the disclosed embodiments are not so limited. In one embodiment, the LED driver 310 can be disposed away from the printed circuit board 306, as is generally shown in FIG. 3E. As was noted with respect to the example of FIG. 1A, in one embodiment, the LED driver 310 can be disposed in the module 140, or in the pole arm 120 pole 130.

In the example of FIG. 3A, one or more of the electrical components of the LED lighting assembly 110 are disposed between the optical part 304 and the printed circuit board 306. For example, the LED module(s) 302 in the example of FIG. 3A are disposed between the optical part 304 and the printed circuit board 306. The heatsink 308 in FIG. 3A is thermally coupled one or more of the electrical components of the LED lighting assembly 110 on the printed circuit board 306. The optical part 304 covers all of the electrical components on the other side of the printed circuit board 306, or the side on which the LED modules 302 are located. In this example, the LED driver 310 is disposed on the same side of the printed circuit board 306 as are the LED modules 302. The LED driver 310 in this example is also covered by the optical part 304.

In one embodiment, referring to FIG. 4, one embodiment of an LED street lighting assembly 400 is illustrated. In this example, the assembly 400 includes a flange portion or covering 402, also referred to as a cover or housing. The flange portion 402, as is described herein, can be applied to the LED lighting assembly 110 of FIG. 3A.

In the embodiment illustrated in FIG. 4, the flange portion 402 comprise an injection-moulded housing. The injection-moulded housing is an injection moulded polymer part that can be used for fixing the different parts of the lighting assembly 110 together and insulation. The various parts and components of the LED lighting assembly 110 of FIG. 3A, also shown in FIG. 4, can be fixed together and insulated by the injection moulded flange portion 402, which is moulded around the functional units of the LED lighting assembly 110. In one embodiment, a portion of the flange portion or member 402 can extend to cover and protect the portions of the printed circuit board 306 that are not covered by the optical cover 304. In this embodiment, the flange portion 402 also comprises a housing for the LED lighting assembly 110, as is generally described herein. The term “insulated” as used with respect to this example generally means to provide protection from the environment and weather, such as by hermetically sealing. When a plug is integrated into the street lighting assembly 400 of the disclosed embodiments, a complete lighting fixture, such as the luminaire assembly 110 can be quickly and easily replaced.

As is illustrated in the embodiment of FIG. 4, in one embodiment, the heat sink 308 is positioned on one side of the PCB 306, which in this example is the side opposite from the side on which the LED modules 302 are disposed. The optical part 304 is positioned on the other side of the PCB 306, or the side on which the LED modules 302 are disposed. The heat sink 308 and the optical part 304 are not fixed together or to the PCB 306 with fasteners. Rather, the flange portion 402, is moulded around all of the edges or junctions 340 of the heat sink 308, PCB 306 and optical part 304. As is illustrated in FIG. 4, the edge or end portions of the heat sink 308, PCB 306 and optical part or cover 304 are coupled together by, or disposed within, the flange portion 402. Once the flange portion 402 is moulded around all of the junctions 340, the flange portion 402 cannot be opened. The components within the assembly 400 are not separately accessible. In case of a failure of the luminaire assembly 400, the entire integrated luminaire assembly 400 is replaced. This is not a disadvantage because the cost of manufacturing the luminaire assembly 400 of the disclosed embodiments is less than that of a typical aluminium cast street light assembly. The lifetime of the integrated LED luminaire assembly 400 of the disclosed embodiments is longer than the typical street light assembly, and being able to replace the entire luminaire assembly 400 also allows for updating the luminaire assembly with up to date, or updated technology.

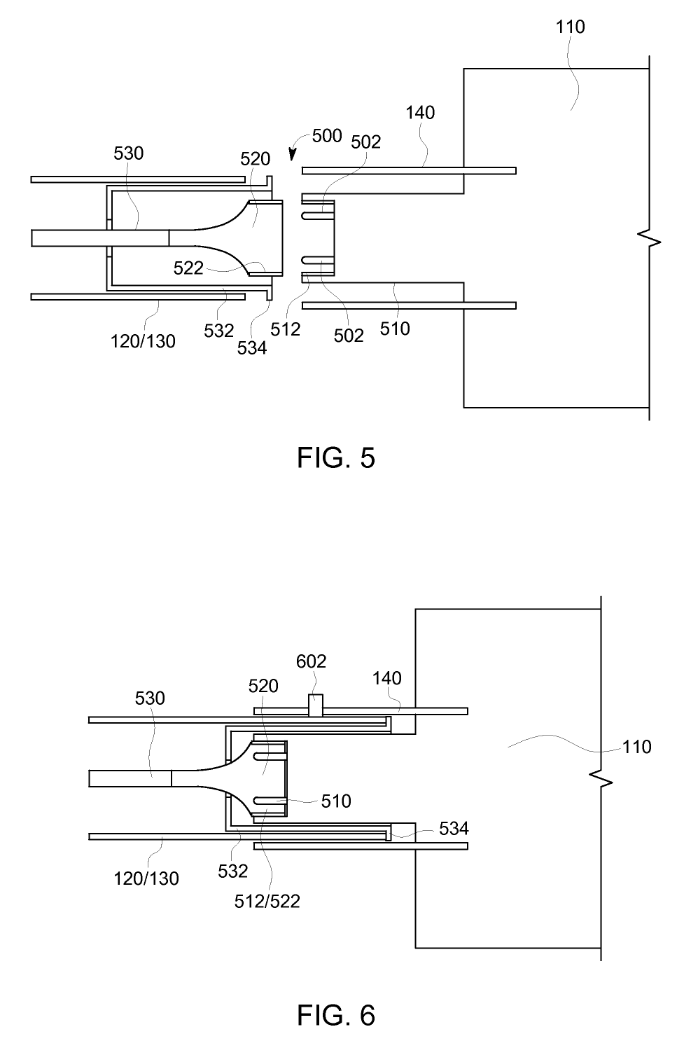

Referring to FIG. 5, in one embodiment an electrical plug or connector assembly 500 is provided that allows the street lighting assembly 400 to be connected to the power grid or supply, even after the flange portion 402 is moulded over and around the junctions 340. In to the example of FIG. 5, the plug assembly 500 includes a first plug member 510 and a second plug member 520. The first plug member 510 and the second plug member 520 are configured to be plugged together and unplugged from each other. In the example of FIG. 5, the first plug member 510 includes electrical prong members 502, while the second plug member 520 includes corresponding prong receiving openings, not shown.

The first plug member 510 is electrically coupled to the LED driver 310 of FIG. 3A or the LED driver module 150 shown in FIG. 1A. Generally, the first plug member 510 will be electrically coupled to the printed circuit board 306 of FIG. 3 to provide electrical power and signalling as required. In the example of FIG. 5, the first plug member 510 is disposed within the modular connector unit 140 of FIG. 1A. In alternate embodiments, the first plug member 510 can be disposed in any suitable location that allows the plug member 510 to be electrically coupled to the electrical components of the LED light assembly 300, including the printed circuit board 306 and LED driver 310.

The second plug member 520 is electrically coupled to a suitable source of electrical power. In one embodiment, the electrical power is provided by an electrical cable 530 in the pole 120 or pole arm 130. The second plug member 520 is configured to couple to the first plug member 510 to complete the electrical power circuit.

In one embodiment, the first plug member 510 is provided inside the modular connector unit 140, also referred to herein as a coupler. In one embodiment, the first plug member 510 can be moulded as part of the assembly 400 shown in FIG. 4. In the example of FIG. 5, the first plug member 510 includes an insulating member 512 that circumscribes an inside surface of an opening of the first plug member 510. The second plug member 520 also includes in this example an insulating member 522 that circumscribes an outer surface of the second plug member 520. The insulating members 512, 522 are generally complementary, and are configured to interface with each other when the first plug member 510 and second plug member 520 are in the connected or plugged in state.

Referring to FIG. 5, in one embodiment, when the second plug member 520 is unplugged or disconnected from the first plug member 510, a bumper member 532 is configured to prevent the second plug member 520 from being retracted into or pulled inside of the pole arm 120 or pole 130. In one embodiment, as is shown in the example of FIG. 5, the bumper member 532 is part of or coupled to the cable 530. In alternate embodiments, the bumper member 532 can be part of or coupled to the pole arm 120 or pole 130.

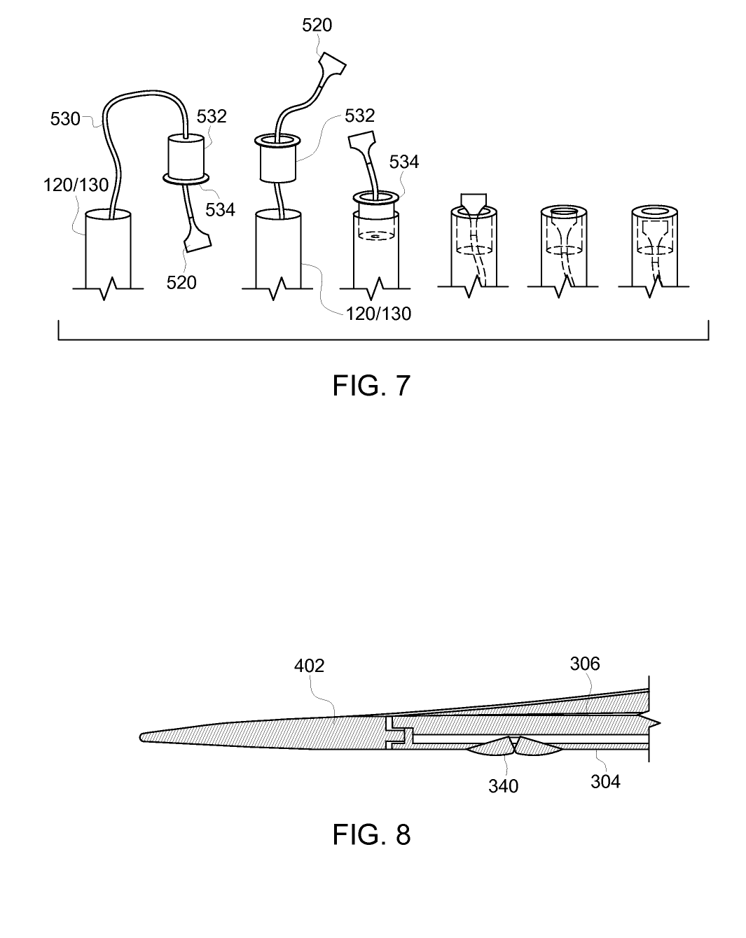

In one embodiment, the bumper member 532 is configured to move along the cable 530, but not allow the cable 530 to fall into the pole arm 120 or pole 130. This is illustrated for example in FIG. 7. A flange member 534 on the outer end or edge of the bumper member 532 is configured to engage or catch on an end of the pole arm 120 or pole 130, also referred to as an outer edge, and prevent the bumper member 532 from falling into the pole 120 or pole arm 130, depending upon the particular configuration being used. The bumper member 532 is configured to maintain the second plug element 520 in a suitable position to allow the first plug element 510 to mate with the second plug element 520. The retention of the flange member 534 on the pole arm 120 or pole 130, as shown in FIG. 5, retains the bumper member 532 in a fixed position to allow the first plug element 510 to suitably engage the second plug element 520.

FIG. 5 illustrates the plug assembly 500 in the unplugged or disconnected state. FIG. 6 illustrates the plug assembly 500 in the plugged or disconnected state. As shown in the example of FIG. 6, a locking mechanism 602 can be used to secure the modular connector unit 140 to the pole arm 130 or pole 120. In one embodiment, the locking mechanism 602 comprises a screw or bolt. In alternate embodiments, any suitable locking mechanism or device can be used to secure the modular connector unit 140 to the pole arm 120 or pole 130.

The aspects of the disclosed embodiments are configured to employ different materials and different orders for the assembly of the different component parts. For example, in one embodiment, one or more material types can be used for the optical part 304 of FIG. 3A. Also, although not shown in FIGS. 3A and 4, a bottom cover (not shown) over the optical part 304 may be employed.

FIG. 8 illustrates one embodiment of a printed circuit board 306 and optical part 304 disposed within an injection moulded housing 402. In this example, the printed circuit board 306 is a metal-core printed circuit board (MCPCB). The optical part 304 comprises a lens/cover assembly.

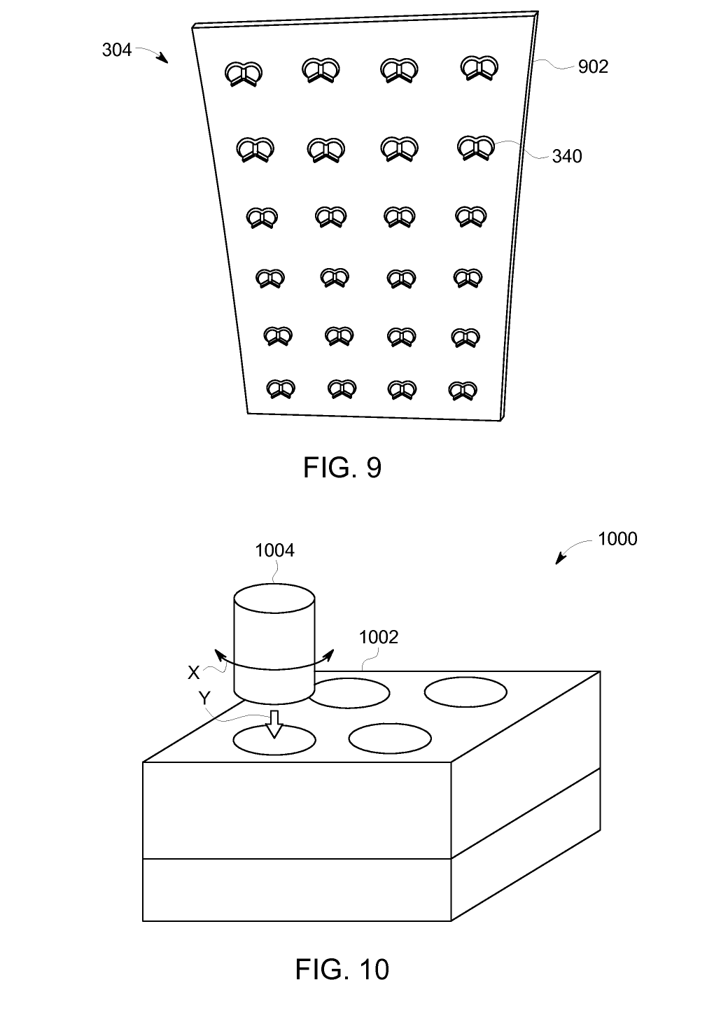

FIG. 9 illustrates one embodiment of an optical part 304 for a street lighting assembly 100 of the present disclosure. In this example, the optical part 304, which can be similar to the optical part or cover 240 of FIG. 2A, comprises a flat optical sheet 902. The optical part 304 is configured to distribute the light emitted by a matrix or array of LED modules 302 to produce an ideal light distribution shape for street lighting. For many outdoor lighting fixtures, it is important to have a flat light emitting surface in order to maintain the “Upper Light Output Ratio” (ULOR) at about zero, and to avoid contamination of the light sources. The light output ratio (LOR) is a figure that shows how much light gets lost inside the luminaire. The light output ratio can be subdivided into the UpperLight Output Ratio (ULOR) or DownwardLight Output Ratio (DLOR)—i.e. what percent shines upwards, and what percent shines downwards. Limiting the amount of light that shine upwards is important to reduce light pollution that might otherwise be realized.

The flat optical sheet 902 is configured to provide weather resistance and mechanical strength in addition to the optical properties. Materials of the flat optical sheet 902 can comprise any suitable optical material, such as for example, polycarbonate, PMMA (poly methyl methacrylate), Polystyrene, glass, and/or the like. In alternate embodiments, any suitable material can be used that will provide the optical, mechanical and weather resistant properties for the LED light assembly described herein.

In one embodiment, the light may be guided through an optical pathway from the surface of the LED module 302, to the outside environment by one or more total internal reflections (TIR). Unlike traditional reflectors, which reflect the light coming from the light source, TIR lenses have no internal losses. The surface of the optical sheet 902 where the light leaves the optical material is flat or has no sharp edges.

The optical sheet 902 can be made from one moulded part, or several overloaded parts, or several glued parts, or parts which are otherwise attached together in order to obtain the desired light distribution shape. The surface of the optical sheet 902 where the light produced by the LED module 302 enters into the optical sheet can 902 be textured, flat or curved.

In some embodiments the optical sheet 902 may contain reflective particles or elements. There may be provided inner obstructions to avoid glare effect of the lighting fixture. Reflective particles may be inserted by overmolding, painting, gluing or any other way. Gaskets, not shown, may be used to seal the optical sheet 902 in the luminaire housing or flange 402.

In one embodiment, the optical part 304 can include one or more lenses 340 to form a lens array. In this example, each lens 340 is a free form optical element ensuring the required light distribution on the street. Each LED in the array may require it is own unique lens geometry. In the example of FIG. 9, a plurality of lenses 340 are arranged on the flat optical sheet 902. The plurality of lenses 340 are arranged in a matrix configuration and fixed together with another material, such as an optical adhesive. In one embodiment, the plastic sheet 902 is transparent and the lens 340 and the plastic sheet 902 comprise the same material. The optical adhesive will have the same or substantially the same refractive index as that of the sheet 902 and lens 340. In an alternate embodiment, only the lenses 904 transmit light. The sheet 902 is not transparent. This alternate embodiment advantageously provides a simpler and less expensive alternative.

Referring to FIG. 10, in one embodiment, a modular tool 1000 for injection-moulded optical parts, such as the optical parts 304 for an outdoor luminaire, such as the assembly 400 of FIG. 4, is provided. The tool 1000 may facilitate the injection moulding of optical parts 304 having varying light distribution for outdoor luminaires.

In one embodiment, the main body 1002 of the injection moulding tool 1000 comprises replaceable parts that are configured to create various geometries for a lens of the optical part 304. These parts may be changed and positioned in arbitrary directions, so as to create selected light distributions in the lens, such as lens 340 of FIG. 9, which is formed by the tool 1000.

The injection moulding tool 1000 may comprise modular parts 1004 with a cylindrical or ribbed surface (not shown). The positioning of the modular part 1004 is guided by the ribs or marks on the outside of the modular part 1004. As is illustrated in FIG. 10 the modular parts 1004 are configured to rotate or move in the directions indicated by arrows X and Y, respectively. The modular part 1004, which is replaceable, can be rotated and positioned in any one of a number of discrete positions.

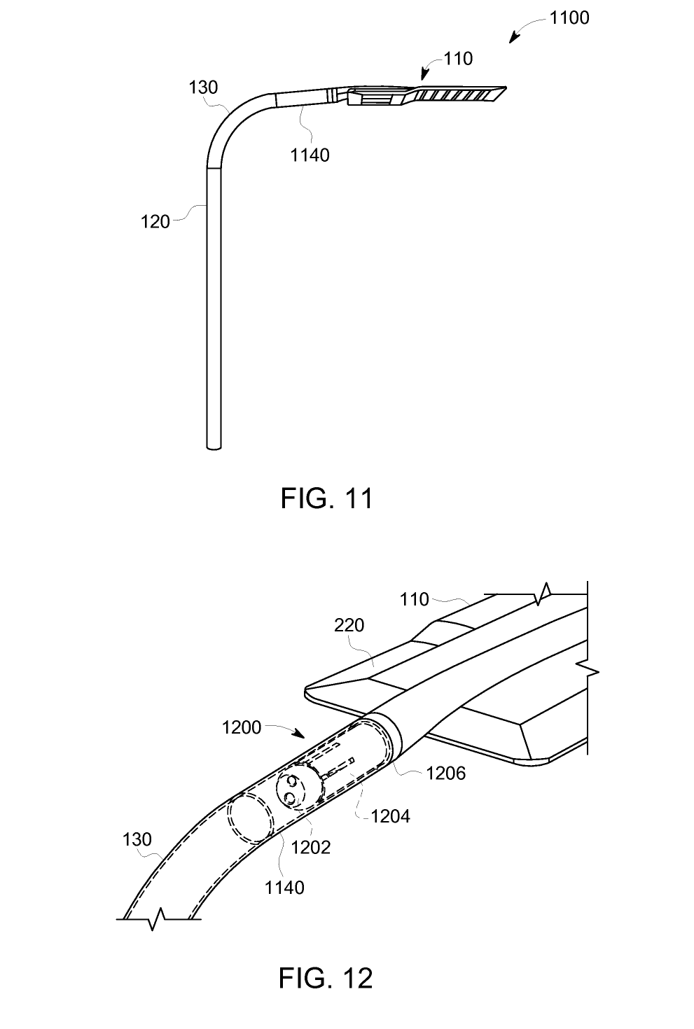

FIG. 11 illustrates another embodiment of an outdoor street lighting assembly or outdoor luminaire 1100. In this example, the outdoor luminaire 1100 includes a pole 120, a pole arm 130, a modular connector assembly 1140 and a lighting assembly 110. In this example, the lighting assembly 110, also referred to as a street lamp assembly, is an assembly of LED modules 302 such as those shown in FIG. 3A.

In the example of FIGS. 11-13, the modular connector assembly 1140 comprises a connection or coupler assembly 1200 for connecting the lighting assembly 110 to the pole arm 130. In alternate embodiments, the modular connector assembly 1140 can be used to connect the lighting assembly 110 to the pole 120, depending on the particular assembly configuration.

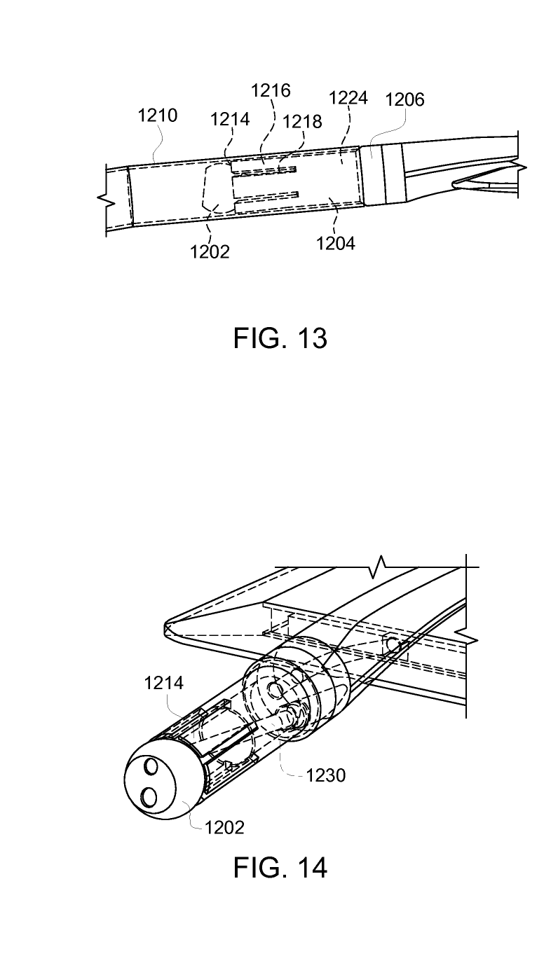

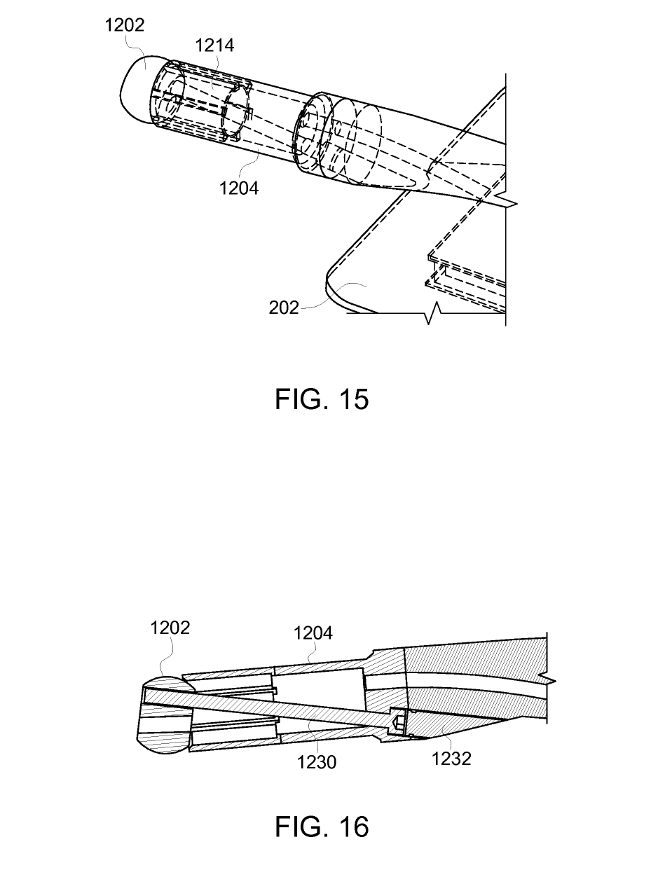

FIGS. 12-13 illustrate the connection assembly 1200, also referred to as a dowel-like connection assembly, which is used to connect the lighting assembly to the pole arm 130. The connection assembly 1200 includes a spherical stretcher member 1202, a dowel member 1204 and a collar member 1206. As will be described herein, referring to FIGS. 14-18, the spherical stretcher member 1202 is configured to cause an end 1224 of the dowel member 1204 to expand. The expansion of the end 1224 of the dowel member 1204 will retain the dowel member 1204 within the housing 1210 for the connection assembly 1200.

Referring to FIGS. 14-16, in one embodiment, a contracting member 1230 is coupled to the spherical stretcher member 1202. As the contracting member 1230 is twisted, the resulting force on the spherical stretcher member 1202 will pull the spherical stretcher member 1202 into the end 1214 of the dowel member 1204. In one embodiment, the contracting member 1230 comprises a socket head cap bolt member. An example of such a socket head cap bolt member is a 10 mm×160 mm socket head cap bolt. In alternate embodiments, the contracting member 1230 can comprise any suitable member that can be used to force the spherical stretcher member 1202 against the end 1214 of the dowel member 1204.

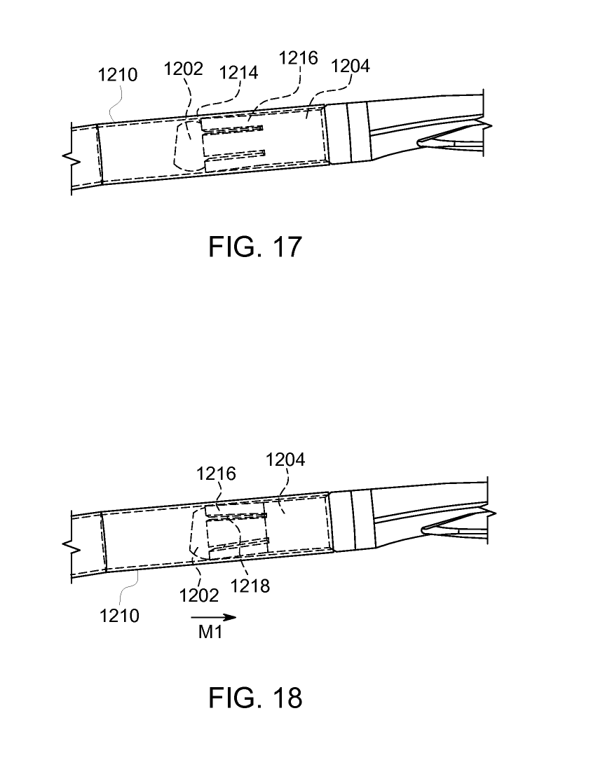

In one embodiment referring to FIG. 16, a blind plug 1232 is coupled to member 1230, and is used to engage and turn the member 1230 to impart the force of the spherical stretcher member 1202 on the end 1214 of the dowel member 1204. The force of the spherical stretcher member 1202 on the end 1214 of the dowel member 1204 results in a flexing of the arm members 1216 of the dowel member 1204. This is illustrated in FIGS. 17 and 18.

In FIG. 17, the spherical stretcher member 1202 is not exerting any force on the dowel member 1204. In the example of FIG. 18, the contraction member 1230 has been turned or twisted to cause the spherical stretcher member 1202 to move in the direction M1 and exert force on the dowel member 1204 and flex the dowel member 1204, and in particular, arm or tang members 1216 of the dowel member 1204. As is shown in FIGS. 17-18, for example, the dowel member 1204 includes slots 1218 between the arm members 1216. The flexed dowel member 1204 secures the lighting assembly 110 to the lamp pole arm 130. In one embodiment, the dowel member 1204 is integral with the housing for the lighting assembly 1100.

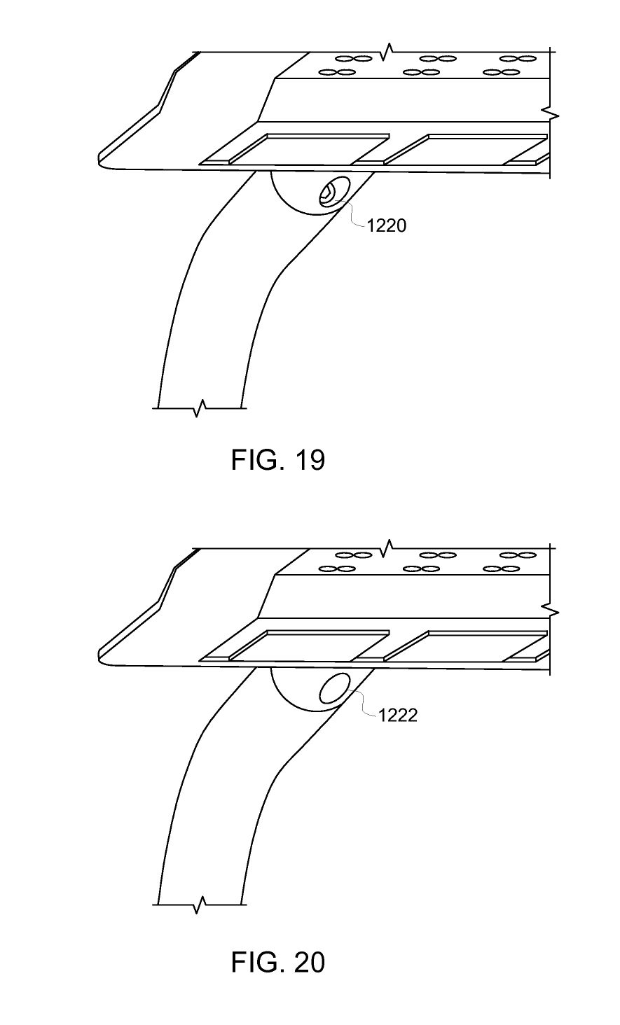

This dowel-like mounting assembly 1200 generally makes the lamp mounting easier. The lamp assembly 110 can be put in its place easily and in certain embodiments can be fixed with one bolt only. Since the mounting take place inside the lamp pole 120/130, none of the components can be seen. FIG. 19 illustrates the opening 1220 that provides access to the blind plug 1232 that can be used to twist the contraction member 1230. As is shown in FIG. 20, a cap member 1222 can be used to cover the opening 1220. This provides an aesthetically pleasing look to the lamp assembly 1100 of the disclosed embodiments.

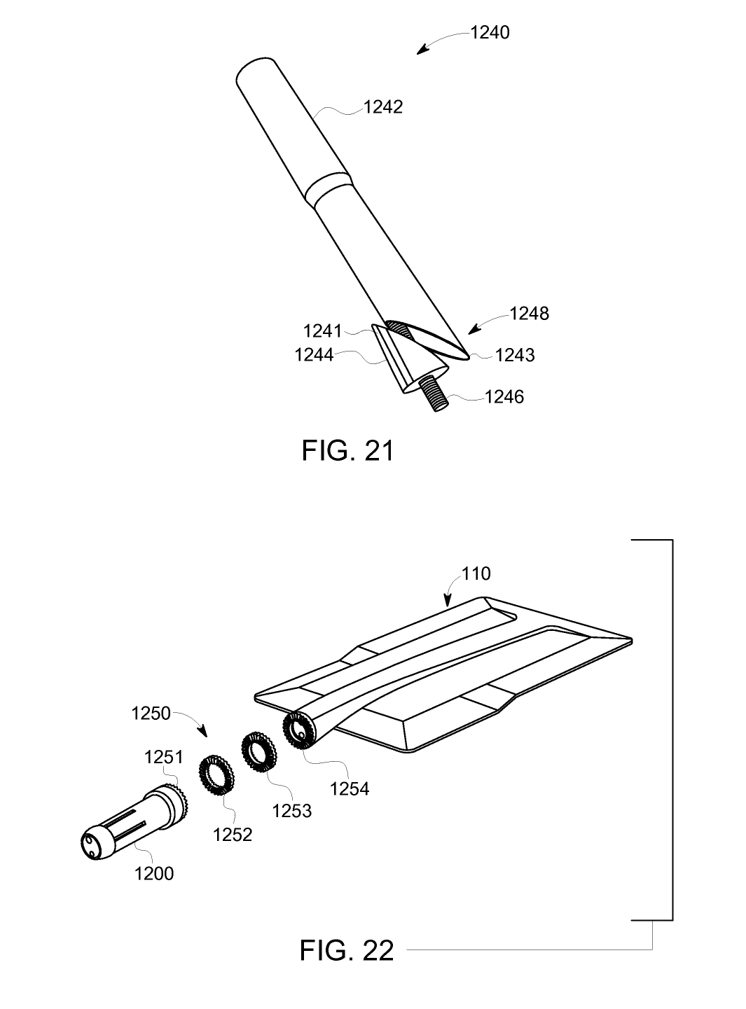

FIG. 21 illustrates an alternative embodiment for the connection assembly 1200. In this example, the connection assembly 1240 comprises a two-part assembly 1242, 1244 that is adjusted with a bolt member 1246. As the bolt member 1246 is turned or twisted, generally in a tightening manner, the two arrow headed parts 1241, 1243 will slide on each other until the assembly 1240 is fixed in the lamp pole 120/130. Essentially, the end 1248 of the assembly 1240 expands as the bolt tightens to secure the assembly within the housing 1210.

In one embodiment, the modular connection assembly 1140 can include an adjustable coupler device 1250. The adjustable coupler device 1250 may be employed between the lamp assembly 110 or luminaire and the dowel like connection assembly 1200 described above. The adjustable coupler device 1250 is generally configured to allow positioning of the lamp assembly 110 relative to the pole 120/130.

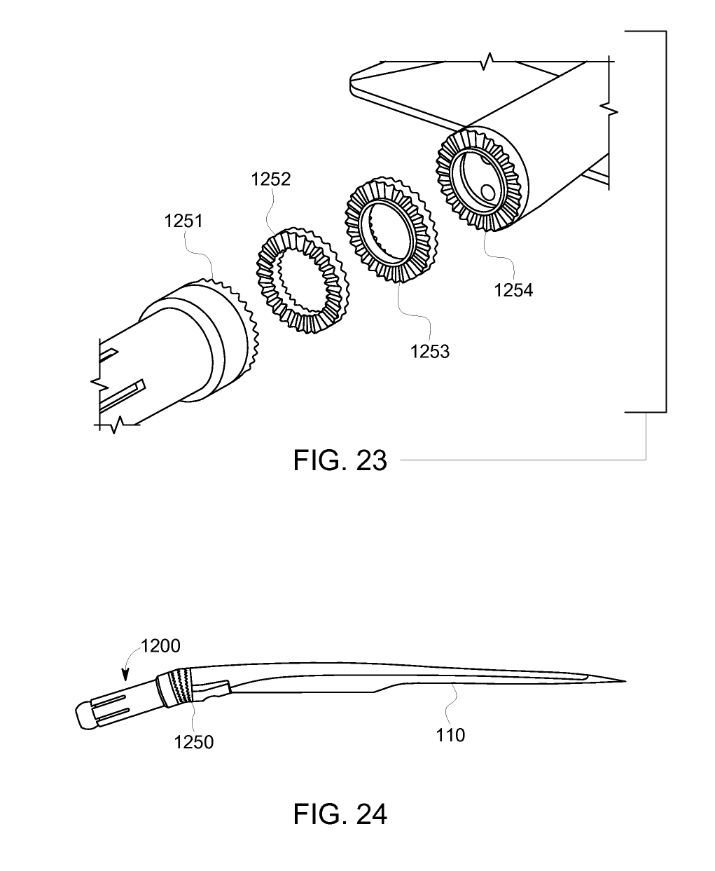

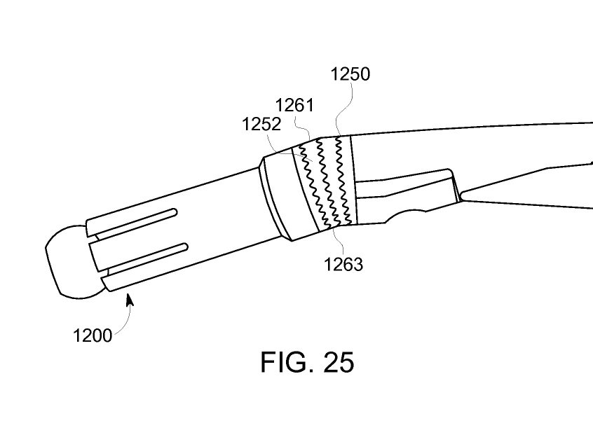

Referring to FIGS. 22 and 23, in one embodiment, the adjustable coupler assembly 1250 comprises a plurality of toothed, annular members 1251-1254 that permit the lamp assembly 110 to be adjusted to a selected angle or position. Although four toothed, annular members 1251-1254 are illustrated in FIGS. 22 and 23, in alternate embodiments, any suitable number of annular members can be used other than including four that will allow for the sufficient degree of position adjustment desired. The annular member 1251-1254 can of any suitable shape and size. In one embodiment, one or more of the annular members 1251-1254 will have an angled configuration that will allow for the position of the lamp assembly 110 to be on an angle relative to the modular connection assembly 1140. An example of this is shown in FIGS. 24 and 25. In the example of FIG. 25, it is seen that one side 1261 of the annular member 1252 is wider than an opposing side 1263. In this manner, one or more of the annular members 1251-1254 can be arranged to provide the desired angle.

As is illustrated in FIGS. 24 and 25, the lamp assembly 110 is coupled to the connection assembly 1200 in an angled or tilted orientation. Thus, when the connection assembly 1200 is inserted into and secure to the pole 120/130, the lamp assembly 110 will be tilted or angled relative to the pole.

The above-described aspects of the disclosed embodiments simplify the manufacturing of luminaires. By these exemplary embodiments, the number of parts used for a luminaire may be decreased, and the requirement for bolts and fasteners to secure the different members in the fixture together may be reduced or eliminated. The injection moulding technology provides protection against dust and water. The replacement process of a lamp module may also be simplified, since it is unnecessary to open a housing to connect the fixture to the main plug.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A street lighting assembly, comprising:
an LED lighting device; and
a printed circuit board disposed within the LED lighting device, the printed circuit board comprising:
an LED light module disposed thereon; and
an LED driver disposed on the printed circuit board and electrically coupled to the LED light module; and
wherein an optical cover is disposed over the LED light module.

2. The street lighting assembly of claim 1, wherein the printed circuit board comprises a first side and a second side with the LED light module and the LED driver being disposed on the first side of the printed circuit board.

3. The street lighting assembly of claim 1, wherein the LED light module is disposed on one side of the printed circuit board and the LED driver is disposed on an other side of the printed circuit board.

4. The street lighting assembly of claim 1, wherein the LED driver comprises a distributed power supply, wherein individual modules of the distributed power supply are interspersed between individual modules of the LED light module.

5. The street lighting assembly of claim 1, comprising a housing disposed over and around an edge of the printed circuit board and optical cover, the injection moulded housing coupling the printed circuit board and optical cover together.

6. The street lighting assembly of claim 5, wherein a portion of the housing covers the printed circuit board.

7. The street lighting assembly of claim 6, comprising a heat sink thermally coupled to a side of the printed circuit board opposite to a side of the printed circuit board facing the optical cover, the housing disposed over and around an edge of the heat sink to couple the heat sink, the printed circuit board and the optical cover together.

8. The street lighting assembly of claim 7, wherein the housing is formed by injection moulding.

9. The lighting assembly of claim 1, comprising an electrical plug assembly having a first plug member and a second plug member, the first plug member being electrically coupled to a power input of the printed circuit board and the second plug member being electrically coupled to a source of electrical power.

10. The street lighting assembly of claim 9, further comprising a pole member, the lighting device being coupled to the pole member and the second plug member is disposed within a housing of the pole member, the second plug member further comprising a bumper member, an outer edge of the bumper member comprising a flange member configured to engage an outer edge of the housing to retain the second plug member within an opening of the housing.

11. The street lighting assembly of claim 1, wherein the optical cover comprises a flat optical sheet.

12. The street lighting assembly of claim 1, wherein the flat optical sheet comprises a plurality of lenses arranged in a matrix configuration, a position of a lens in the optical sheet being aligned with an optical output of a corresponding LED light module.

13. A street lighting assembly, comprising:
an LED lighting device and a pole member;
a modular connector unit coupling the LED lighting device to the pole member; and
an optical cover disposed over a lighting portion of the LED lighting device,
wherein the LED lighting device comprises:
a printed circuit board;
an LED light module disposed on the printed circuit board; and
an LED driver disposed on the printed circuit board.

14. The street lighting assembly of claim 13, wherein the modular connector assembly comprises a connection assembly for coupling the LED lighting fixture to the pole member, the connection assembly comprising:
a spherical stretcher member;
a dowel member; and
a collar member, wherein the spherical stretcher member is configured to engage and expand an end of the dowel member when the dowel member is compressed between the spherical stretcher member and the collar member.

15. The street lighting assembly of claim 14, comprising a contracting member coupled to the spherical stretcher member at one end and a retaining member at an other end, the contracting member configured to pull the spherical stretcher member into the end of the dowel member.

16. The street lighting assembly of claim 13, wherein the optical cover comprises a flat optical sheet.

17. The street lighting assembly of claim 16, wherein the flat optical sheet comprises a plurality of lenses arranged in a matrix configuration, a position of a lens in the optical sheet being aligned with an optical output of a corresponding LED light module.

18. The street lighting assembly of claim 13, comprising a housing disposed over and around an edge of the printed circuit board and optical cover, the injection moulded housing coupling the printed circuit board and optical cover together.

19. The street lighting assembly of claim 18, where the housing forms a hermetic seal over the printed circuit board and around a joining edge of the printed circuit board and optical cover.

20. The street lighting assembly of claim 13, comprising an electrical plug assembly having a first plug member and a second plug member, the first plug member being electrically coupled to a power input of the printed circuit board and the second plug member being electrically coupled to a source of electrical power and disposed within a housing of the pole member, the second plug member further comprising a bumper member, an outer edge of the bumper member comprising a flange member configured to engage an outer edge of the housing to retain the second plug member within an opening of the housing.
